(19) United States
(12) Patent Application Publication
(10) Pub. No.: US 2009/0309279 A1
(43) Pub. Date: Dec. 17, 2009

(54) Air-Damping Engine Mount

(75) Inventors: Young Dal Kim, Daegu (KR); Jeong Hoon Kim, Seoul (KR)

Correspondence Address: MORGAN, LEWIS & BOCKIUS LLP (SF), One Market, Spear Street Tower, Suite 2800, San Francisco, CA, 94105, US

(73) Assignees: Hyundai Motor Company, Seoul (KR); Pyung Hwa Industrial Co., LTD., Daegu (KR)

(21) Appl. No.: 12/325,934

(22) Filed: Dec. 1, 2008

(30) Foreign Application Priority Data
Jun. 12, 2008 (KR) 10-2008-0055300

(51) Int. Cl. F16F 9/04; B60K 5/12

(52) U.S. Cl. 267/140.11; 180/291

(57) ABSTRACT

An air-damping mount, in which a displaceable bellows plate is mounted in order to define a damping chamber. A rigid or displaceable partition plate having at least a through-hole is mounted in the damping chamber, and thereby partitions the damping chamber into an upper chamber and a lower chamber. At least an orifice tube is mounted on and connected with the through-hole so as to allow the upper and lower chambers to fluidly communicate with each other. Thereby, the air-damping engine mount can reduce engine vibration by means of flow resistance of air occurring when the air passes through the through-hole and the orifice tube and by means of displacement of the displaceable bellows plate caused by a change in pressure of the lower chamber, and thus remarkably improve a damping effect of the engine vibration.

### CROSS-REFERENCE TO RELATED APPLICATION

This application claims priority to Korean Patent Application No. 10-2008-0055300 filed on Jun. 12, 2008 in the Korean Intellectual Property Office, the entire contents of which is incorporated herein for all purposes by this reference.

### BACKGROUND OF THE INVENTION

1. Field of the Invention

The present invention relates to an air-damping engine mount, and more particularly, to an air-damping engine mount, in which a displaceable bellows plate is mounted in order to define a damping chamber, in which a partition plate having a through-hole is mounted to thereby partition the damping chamber into an upper chamber and a lower chamber, and in which an orifice tube is mounted on and connected with the through-hole so as to allow the upper and lower chambers to fluidly communicate with each other. The air-damping engine of the present invention reduces engine vibration by means of flow resistance of air occurring when the air passes through the through-hole and the orifice tube as well as displacement of the displaceable bellows plate caused by a change in pressure of the lower chamber, and thus remarkably improving a damping effect of the engine vibration.

2. Description of Related Art

In general, an engine mount is used to mount an engine of a motor vehicle to a vehicle body, and functions not only to connect and support the engine to and on the vehicle body but also to absorb vibration and noise transmitted from the engine to the vehicle body.

Among the conventional engine mount having these functions, hydro mounts having an interior provided with a fluid chamber and filled with a fluid such as oil, or a conventional mounts formed entirely of rubber without a fluid chamber, are widely used.

The conventional mount made entirely of rubber has a small number of parts to provide a simple producing process and an inexpensive price, but has low damping efficiency to fails to sufficiently absorb the vibration and noise.

Further, the hydro mount, which has an interior provided with a fluid chamber and is filled with a fluid such as oil, has high damping efficiency to sufficiently absorb the vibration and noise, but has a large number of parts and requires a sealing structure for sealing the fluid, which makes a producing process complicated and considerably increases a price.

In order to overcome the disadvantages of such hydro mounts or conventional mounts, an air-damping engine mount that performs a damping function using pneumatic pressure has recently been developed.

FIG. 1 is a schematic cross-sectional view illustrating the structure of a conventional air-damping engine mount.

As illustrated in FIG. 1, the ordinary air-damping engine mount according to the conventional art includes a center bolt 10, which is coupled with a vehicle engine, a main rubber body 20, into and to the center of which the center bolt 10 is inserted and coupled, a hollow main pipe 30, which supports the main rubber body 20 and is fixedly coupled with the main rubber body 20, and a cover plate 40, which is fixedly coupled to one end of the main pipe 30 such that a damping chamber 50 is defined together with the main rubber body 20.

At this time, the cover plate 40 is provided with a through-hole 41 such that the damping chamber 50 fluidly communicates with the outside. The air in the damping chamber 50 is discharged to or introduced from the outside through the through-hole 41.

In this manner, as the air in the damping chamber 50 is discharged to or introduced from the outside, the vibration of the main rubber body 20 is damped.

In detail, when the main rubber body 20 is deformed downwards by engine vibration, the pressure in the damping chamber 50 is increased, and thus the air is discharged to the outside through the through-hole 41. At this time, the vibration of the main rubber body 20 is instantaneously damped by flow resistance occurring when the air is discharged to the outside.

However, the air-damping engine mount having this structure directly fluid-communicates with the outside by means of the through-hole 41, and has very weak flow resistance of the air flowing in and out in terms of the air property, so that it has little effect on the vibration damping of the engine.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide an air-damping engine mount. The air-damping engine mount may include a main rubber body, into which a vehicle-engine center bolt is inserted and coupled, a hollow main pipe substantially encircling the main rubber body and supporting the main rubber body, a bellows plate coupled to one end of the main pipe and defining a damping chamber together with the main rubber body, wherein the bellows plate is displaceable according to a change in pressure in the damping chamber, and/or a partition plate mounted in the damping chamber and partitioning the damping chamber into an upper chamber and a lower chamber. The upper chamber may be defined by the main rubber body and the partition plate, and the lower chamber may be defined by the partition plate, the main rubber body, and the bellows plate, the partition plate including a through-hole such that the upper chamber fluidly communicates with the lower chamber. The through-hole may be dimensioned and configured to dampen vibration of the vehicle engine by flow resistance of air passing through the a through-hole, and the bellows plate and/or the partition plate may be dimensioned and configured to dampen vibration by displacement thereof.

The partition plate may include an orifice tube so as to fluidly communicate air between the upper and lower chambers flows via the through-hole and the orifice tube. The orifice tube may be linear-shaped. The partition plate may be displaceable. The orifice tube may protrude from the through-hole to the lower chamber. The orifice tube may be inclined so as to be oriented from an outer portion of the partition plate toward a center of the lower chamber.

Another aspect of the present invention is directed to an air-damping engine mount system. The mount system may include comprising a vehicle engine, a main rubber body, into which a vehicle-engine center bolt is inserted and coupled, a hollow main pipe substantially encircling the main rubber body and supporting the main rubber body, a bellows plate coupled to one end of the main pipe and defining a damping chamber together with the main rubber body, wherein the bellows plate is displaceable according to a change in pressure in the damping chamber, and/or a partition plate mounted in the damping chamber and partitioning the damping chamber into an upper chamber and a lower chamber. The upper chamber may be defined by the main rubber body and the partition plate, and the lower chamber may be defined by the partition plate, the main rubber body, and the bellows plate. The partition plate may include a through-hole such that the upper chamber fluidly communicates with the lower chamber. Vibration of the vehicle engine may be damped by flow resistance of air passing through the through-hole.

Vibration of the engine may be dampened by displacement of the bellows plate and/or displacement of the partition plate.

A passenger vehicle may include the above described air-damping engine mount and/or the above-described the air-damping engine mount system.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view illustrating the structure of an air-damping engine mount.

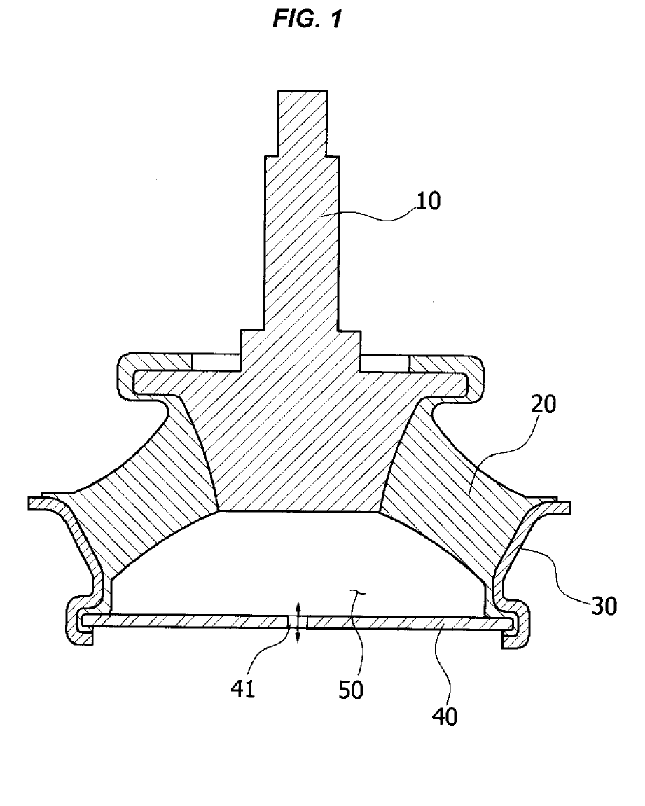

FIG. 2 is a cross-sectional view illustrating the structure of an air-damping engine mount according to various aspects of the present invention.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

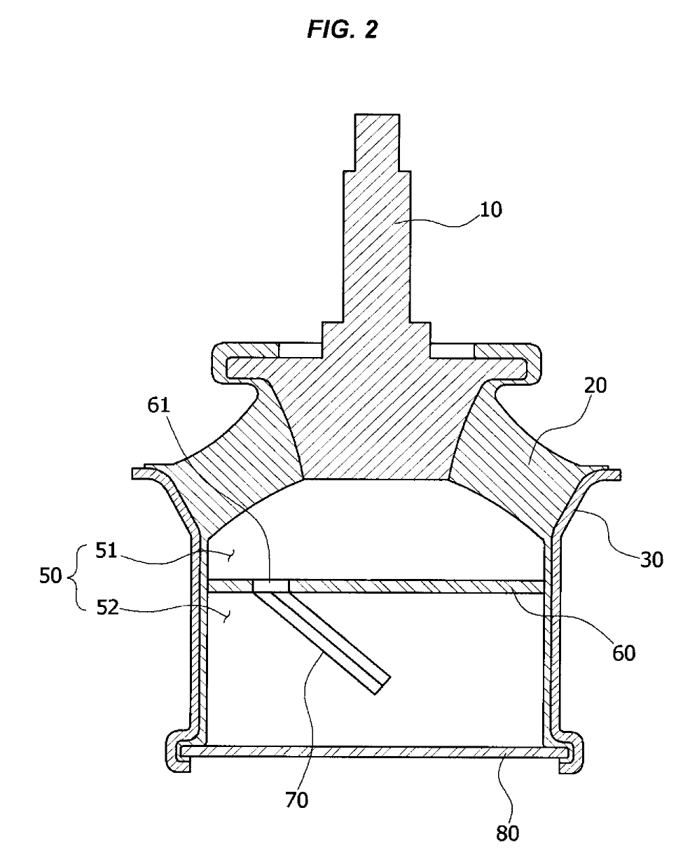

FIG. 2 is a cross-sectional view illustrating the structure of the air-damping engine mount according to an exemplary embodiment of the present invention.

As illustrated in FIG. 2, the air-damping engine mount according to an exemplary embodiment of the present invention includes: a main rubber body 20, into and to which a center bolt 10 coupled with a vehicle engine is inserted and coupled; a hollow main pipe 30 substantially enclosing and supporting the main rubber body 20; a displaceable bellows plate 80, which is fixedly coupled to one end of the main pipe 30 such that a damping chamber 50 is defined together with the main rubber body 20, and is displaceable according to a change in pressure therein; and a rigid or displaceable partition plate 60, which is mounted in the damping chamber 50 such that the damping chamber 50 is partitioned into an upper chamber 51 and a lower chamber 52, and is provided with a through-hole 61 such that the upper chamber 51 fluidly communicates with the lower chamber 52, wherein the vibration of the vehicle engine is damped by flow resistance of air passing through the through-hole 61 and by displacement of the displaceable bellows plate 80 caused by a change in pressure of the lower chamber 52.

In various exemplary embodiments of the present invention, the partition plate 60 may be rigid.

Since the partition plate 60 has the through-hole 61, through which the air can flow such that the upper chamber 51 fluidly communicates with the lower chamber 52, the displaceable bellows plate 80 is adapted to generate displacement according to a change in pressure of the lower chamber 52.

Thus, the air-damping engine mount according to an exemplary embodiment of the present invention functions to dampen the vibration of the vehicle engine by means of the flow resistance of the air passing through the through-hole 61 and the displacement of the bellows plate 80 caused by the pressure change of the lower chamber 52.

More specifically, when the upper chamber 51 is contracted, the pressure of the upper chamber 51 is increased. Thereby, the air stored in the upper chamber 51 flows through the through-hole 61 of the partition plate 60 to the lower chamber 52. At this time, the vibration transmitted from the vehicle engine is instantaneously damped by the flow resistance of the air flowing through the through-hole 61. In addition, the air flowing through the through-hole 61 moves to the lower chamber 52, so that the pressure of the lower chamber 52 is increased. Thereby, the bellows plate 80 is displaced downwards. This displacement causes the vibration of the vehicle engine to be damped again.

In various exemplary embodiments of the present invention, the partition plate 60 may be displaceable. For example, when the upper chamber 51 is contracted, the pressure of the upper chamber 51 is increased and thereby the partition plate 60 may be displaced downwards. This displacement of the partition plate 60 may cause the vibration of the vehicle engine to be damped again. Moreover, the air stored in the upper chamber 51 may flow through the through-hole 61 of the partition plate 60 to the lower chamber 52.

The vibration transmitted from the vehicle engine may be instantaneously damped by the flow resistance of the air flowing through the through-hole 61. In addition, the air flowing through the through-hole 61 moves to the lower chamber 52, so that the pressure of the lower chamber 52 is increased. Thereby, the bellows plate 80 is displaced downwards. This displacement causes the vibration of the vehicle engine to be damped again.

Thus, the air-damping engine mount according to exemplary embodiments of the present invention is designed to simultaneously or sequentially perform a damping function based on the flow resistance of the air and a damping function based on the displacement of the partition plate 60 and bellows plate 80 or the bellows plate 80, so that it is a structure in which a damping effect on the engine vibration is very improved as compared to a conventional one.

Further, as illustrated in FIG. 2, according to an exemplary embodiment of the present invention, the partition plate 60 is mounted with an orifice tube 70 so as to fluidly communicate with the through-hole 61. The air flowing between the upper chamber 51 and the lower chamber 52 through this orifice tube 70 passes through the through-hole 61 as well as the orifice tube 70, and thus functions to damp the engine vibration. In this manner, since the air passes through the through-hole 61 as well as the orifice tube 70, the flow resistance thereof is relatively increased, and thus the vibration damping effect is also improved.

In further another exemplary embodiment of the present invention, as illustrated in FIG. 2, the orifice tube 70 has the shape of a linear pipe, and is mounted on the partition plate 60 so as to be connected to the through-hole 61. Alternatively, the orifice tube 70 may be designed to form a linear or curved orifice channel in the partition plate 60. This orifice tube can be modified in a variety of sizes and shapes as needed by a user.

Further, the orifice tube 70 can protrude from the through-hole 61 toward the upper chamber 51 or the lower chamber 52. As illustrated in FIG. 2, according to an exemplary embodiment of the present invention, the orifice tube 70 is preferably formed so as to protrude from the through-hole 61 toward the lower chamber 52. Thus, a flow of the air can be made smoother.

Furthermore, the orifice tube 70 is preferably disposed at a predetermined length such that the flow resistance of the air can be increased. The orifice tube 70 is preferably disposed such that the bellows plate 80 can be more smoothly displaced downwards. To this end, as illustrated in FIG. 2, the through-hole 61 is formed in an outer edge of the partition plate 60, and the orifice tube 70 is inclined so as to be oriented from the outer edge of the partition plate 60 to the center of the lower chamber 52.

For convenience in explanation and accurate definition in the appended claims, the terms “up” or “upper”, “down” or “lower”, “front” or “rear”, “inside”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An air-damping engine mount, comprising:
a main rubber body, into which a vehicle-engine center bolt is inserted and coupled;
a hollow main pipe substantially encircling the main rubber body and supporting the main rubber body;
a bellows plate coupled to one end of the main pipe and defining a damping chamber together with the main rubber body, wherein the bellows plate is displaceable according to a change in pressure in the damping chamber; and
a partition plate mounted in the damping chamber and partitioning the damping chamber into an upper chamber and a lower chamber, wherein the upper chamber is defined by the main rubber body and the partition plate, and the lower chamber is defined by the partition plate, the main rubber body, and the bellows plate, the partition plate including a through-hole such that the upper chamber fluidly communicates with the lower chamber,
wherein the through-hole is dimensioned and configured to dampen vibration of the vehicle engine by flow resistance of air passing through the a through-hole, and the bellows plate and/or the partition plate are dimensioned and configured to dampen vibration by displacement thereof.

2. The air-damping engine mount according to claim 1, wherein the partition plate includes an orifice tube so as to fluidly communicate air between the upper and lower chambers flows via the through-hole and the orifice tube.

3. The air-damping engine mount according to claim 2, wherein the orifice tube is linear-shaped.

4. The air-damping engine mount according to claim 2, wherein the partition plate is displaceable.

5. The air-damping engine mount according to claim 2, wherein the orifice tube protrudes from the through-hole to the lower chamber.

6. The air-damping engine mount according to claim 5, wherein the orifice tube is inclined so as to be oriented from an outer portion of the partition plate toward a center of the lower chamber.

7. An air-damping engine mount system, comprising:
a vehicle engine, a main rubber body, into which a vehicle-engine center bolt is inserted and coupled;
a hollow main pipe substantially encircling the main rubber body and supporting the main rubber body;
a bellows plate coupled to one end of the main pipe and defining a damping chamber together with the main rubber body, wherein the bellows plate is displaceable according to a change in pressure in the damping chamber; and
a partition plate mounted in the damping chamber and partitioning the damping chamber into an upper chamber and a lower chamber, wherein the upper chamber is defined by the main rubber body and the partition plate, and the lower chamber is defined by the partition plate, the main rubber body, and the bellows plate, and the partition plate includes a through-hole such that the upper chamber fluidly communicates with the lower chamber,
wherein vibration of the vehicle engine is damped by flow resistance of air passing through the through-hole.

8. The air-damping engine mount system according to claim 7, wherein vibration of the engine is dampened by displacement of the bellows plate and/or displacement of the partition plate.

9. A passenger vehicle comprising the air-damping engine mount of claim 1.

10. A passenger vehicle comprising the air-damping engine mount system of claim 7.
